(19) United States
(12) Patent Application Publication
(10) Pub. No.: US 2009/0124352 A1
(43) Pub. Date: May 14, 2009

(54) SLOT MACHINE GAME WITH SIDE POT

(76) Inventor: Ignacio Gerson, Buenos Aires (AR)

Correspondence Address: MUSKIN & CUSICK LLC, 30 Vine Street, SUITE 6, Lansdale, PA, 19446, US

(21) Appl. No.: 11/949,749

(22) Filed: Dec. 3, 2007

Related U.S. Application Data
(60) Provisional application No. 60/987,770, filed on Nov. 13, 2007.

(51) Int. Cl. G07F 17/34

(52) U.S. Cl. 463/25

(57) ABSTRACT

A slot machine method, apparatus, and computer readable storage to implement a side pot. A main credit meter is maintained as well as a side pot. The main credit meter and the side pot can be awarded based on different paytables (one for the main credit meter and one for the side pot). Thus, a player can achieve additional excitement by having additional award possibilities.

### CROSS REFERENCE TO RELATED APPLICATIONS

This Application claims benefit to provisional application 60/987,770, which is incorporated by reference herein in its entirety.

This application is also related to the following ten applications identified by their application number, all ten applications are incorporated by reference herein in their entireties: Ser. No. 11/035,691 (“Slot Machine Game that Allows Player to Purchase Reel Respins”); Ser. No. 11/326,125 (“Slot Machine Bonus Game); Ser. No. 11/337,960 (“Slot Machine with Skill Aspect”); Ser. No. 11/558,405 (“System and Method for Allowing Piggyback Wagering”); Ser. No. 11/609,315 (“System and Method for Allowing Piggyback Wagering”); Ser. No. 11/459,253 (“Slot Machine Bonus Game”); Ser. No. 11/558,564 (“System and Method for Administering a Progressive Jackpot Limited to a Bonus Round”); Ser. No. 11/11/678,050 (“Slot Machine Game With Additional Features”); Ser. No. 11/764,689 (“Slot Machine Game with Additional Award Indicator”); and Ser. No. 11/776,508 (“Slot Machine Game With User Selectable Themes”). All ten of these applications are incorporated by reference herein in their entireties for all purposes. Any and all features of any of these applications can be combined with each other and with any feature(s) described herein.

### BACKGROUND OF THE INVENTION

1. Field of the Invention

The present inventive concept relates to a system, method, and computer readable storage, for providing additional award opportunities to slot machine games.

2. Description of the Related Art

Slot machine games are a billion dollar industry. The current three or five reel machines have been around for a long time and some players may find current game play monotonous.

What is needed is a slot machine with additional slot machine features which will generate more excitement for players and/or more revenue as well.

### SUMMARY OF THE INVENTION

It is an aspect of the present general inventive concept to provide additional features to slot machine games.

The above aspects can also be obtained by a method that includes (a) outputting a credit meter amount and a side pot amount; (b) receiving a main wager from a player, the main wager being deducted from the credit meter amount; (c) spinning slot machines reels to a random resulting combination; (d) determining an award based on the resulting combination, and awarding any such award; (e) determining an effect of the resulting combination on the side pot amount; and (f) adjusting the side pot amount based on the effect.

The above aspects can also be obtained by a method that includes (a) outputting a credit meter amount and a side pot amount; (b) receiving a main wager from a player, the main wager being deducted from the main credit meter amount; (c) spinning slot machines reels to a random resulting combination; (d) determining if a main award is earned based on the resulting combination, and if so, awarding any such award by increasing the main credit meter; (e) determining if a side pot is affected by the resulting combination, and if so, adjusting the side pot based on the resulting combination; and (f) determining if an award transfer is earned based on the resulting combination, and if so, transferring a transfer amount of credits from the side pot to the main credit meter, (g) wherein the player can cash out the credits in the main credit meter but not the side pot.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of implementing a wagering method with a side pot, according to an embodiment;

FIG. 2 is a drawing illustrating an example of a slot machine with a side pot, according to an embodiment;

FIG. 3 is a flowchart illustrating an exemplary method of implementing a wagering method with a side pot with automatic cashouts, according to an embodiment; and

FIG. 4 is a block diagram of one example of hardware that can be used to implement the method, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

Embodiments of the invention relate to slot machine games, where a player typically places a main wager, presses a button to spin the reels, the reels each stop at a random position. Payouts are then determined by comparing all paylines played to a predetermined set of winning combinations, and then the determined payouts, if any, are awarded to the player based on the main wager. Additional features can augment the excitement of a player and may also result in increased action for the casino.

Slot machines typically have a (main) credit meter. A credit meter is an output device which indicates to the player how many credits the player currently owns. For example, if the player has $100 of credits in the machine that the player can cash out, the credit meter will read $100. The player can typically add to (by inserting cash into the machine) or cash out the credit meter at the player's discretion.

A slot machine can have a side pot. The side pot meter outputs an amount of credits in the side pot. The side contains credits that the player “owns” but is awarded and debited in a different manner than a main credit meter. The side pot can be initially funded by the player, in other words the player can transfer credits from the main credit meter into the side pot. In a further embodiment, the player does not own these side credits outright but must hit certain combination(s) in order be able to obtain credits in the side pot (side pot meter).

The side pot can be affected by resulting symbol combinations on the slot reels. For example, the player places a main (standard) slot wager (deducted from the main credit meter), spins reels to a random resulting symbol combination, and is awarded a main award (to the main credit meter) based on the main wager if the resulting symbol combination is one of a predetermined number of winning combinations. The side pot can also be affected by the resulting symbol combination but according to a different set of rules than the main award.

For example, if certain symbols appear on the reels (or a predetermined reel), then it can affect the side pot. For example, if a “stock up 5%” symbol appears, then the side pot can increase by 5 percent. If a “wipeout” symbol appears, then the entire side pot can be wiped out (set to zero). If a “stock down 10%” symbol appears, then the side pot can decrease by 10%. If a “stock up $5” appears then the side pot can increase by $5. If a “stock down $3” symbol appears, then the side pot can decrease by $3.

In this way, as the player plays the slot game, the main credit meter and the side pot may have different award amounts. For example, the main credit meter can win an award while the side pot will decrease, or the main credit meter will not win while the side pot can increase, or the main credit meter can win (or not) while the side pot stays the same.

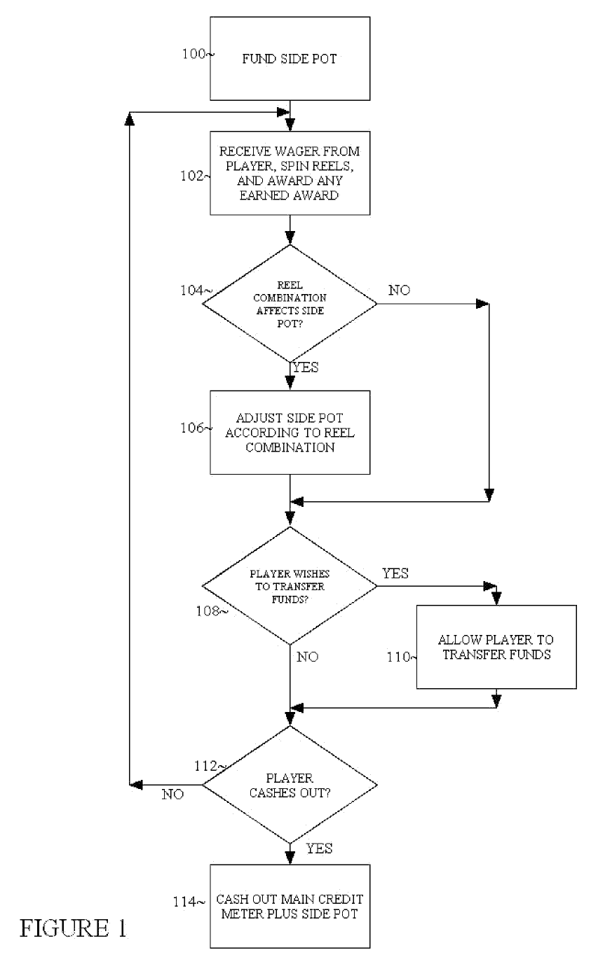

FIG. 1 is a flowchart illustrating an exemplary method of implementing a wagering method, according to an embodiment.

The method starts with operation 100, wherein the player funds the side pot. The player can fund the side pot by transferring money from the main credit meter into the side pot. The player can do this using buttons and/or a touch screen interface. The player can choose to fund the side pot with an amount of the player's choice.

As an alternative to the player funding the side pot, if the player plays the slot machine and a predetermined combination appears on the reels, then this can automatically fund the side pot. For example, if three “bell” symbols appear, then this can automatically fund (or add to) the side pot by a predetermined amount (e.g., $4).

From operation 100, the method can proceed to operation 102, which receives a wager from the player, spins the reels of the slot machine to a random resulting symbol combination, and awards the player any earned award based on the resulting symbol combination. This can be done as known in the art. The player can place a cash amount in the main credit meter, and whenever the player plays the slot game (spins the reel), an amount of the latest wager is deducted from the main credit meter. Thus, typically, the main credit meter is used to fund the main game which, upon hitting a winning combination on the slot reels, awards credits to the player in the main credit meter.

From operation 102, the method can proceed to operation 104, which determines whether the reel combination affects the side pot. Certain predetermined combinations of the resulting symbol combination would affect the side pot. If the resulting symbol combination has no affect on the side pot, then the method can proceed to operation 108.

If the resulting symbol combination has an affect on the side pot, then the method can proceed to operation 106, which adjusts the side pot based on the resulting symbol combination. A paytable can be used which maps predetermined symbol combinations to particular affects of the side pot.

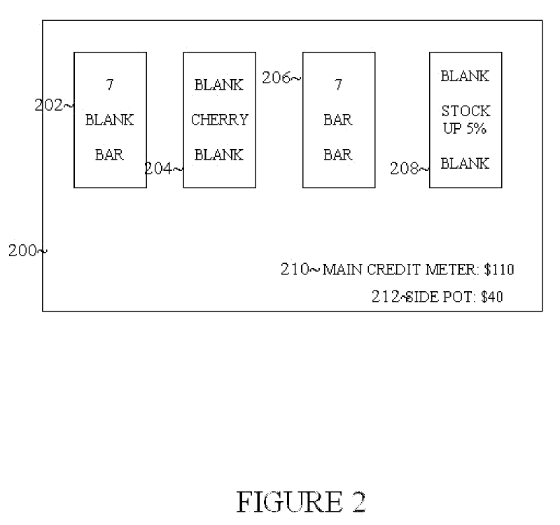

In addition (or alternatively) to using the reels to affect the side pot, an extra reel can be used which is the only reel which can affect the side pot. For example, in a three reel game with three standard reels used to determine the standard payouts on the main wager, a fourth reel can be used to affect the side pot. Whatever symbol appears on the fourth reel will determine the affect on the side pot. Table I below illustrates one example of a set of symbols on a fourth (or any numbered) reel used to affect a side pot. This fourth reel can be, for example, the fourth reel 208 illustrated in FIG. 2.

TABLE I

| Reel stop | symbol name | symbol effect |
|---|---|---|
| 1 | wipeout | side pot = $0 |
| 2 | blank | no effect |
| 3 | up 5% | increase side pot by 5% |
| 4 | down 6% | decrease side pot by 6% |
| 5 | increase $8 | increase side pot by $8 |
| 6 | decrease $9 | decrease side pot by $9 |
| 7 | increase random | increase side pot by a random number |
| | | from $1-$15 |
| 8 | decrease random | decrease side pot by a random number |
| | | from $1-$15 |

Table I above uses an additional reel to affect the side pot. The main reels only affect an award for the main credit meter. In an alternate embodiment, the main reels used to award a payout on the main wager can also be used to affect the side pot. For example, Table II below illustrates an example of a three reeled game with payouts on the main wager and affects on the side pot.

TABLE II

| Reel combination | main wager | side pot |
|---|---|---|
| 7-7-7 | pays 100:1 | doubles side pot |
| blank-blank-blank | pays 0 | decreases side pot by 10% |
| cherry-any-any | pays 2:1 | no affect on side pot |
| bar-bar-bar | pays 5:1 | wipes out side pot |
| bell-bar-bell | pays 0 | increase side pot by $5 |

For example, using Table II, a player plays a three reel slot machine with $100 in the main credit meter and $20 in the side pot. The player wagers $1 and spins the reels. The main credit meter now drops to $99. The resulting symbol combination is a blank-blank-blank. The main credit meter stays at $99 (since the player has not won anything) and the side pot drops down to $18 (since it loses 10% of its value). The player wagers $1 again, and spins the reels, causing the main credit meter to drop to $98. The resulting reel combination is now 7-7-7. The player wins an award of $100 on the main wager (for the main game), thus the main credit meter now reads $198. The side pot meter now reads $36 since the resulting reel combination of 7-7-7 doubles the side pot.

From operation 106, the method can proceed to operation 108, which determines if the player wishes to transfer funds between the main credit meter and the side pot. The player is free to transfer funds (an amount of the player's choice) from the main credit meter into the side pot and from the side pot into the main credit meter. If the player does not wish to transfer funds, then the method can proceed to operation 112. The player can indicate his or her wish to transfer funds, for example, by pressing a button (either physical our virtual) on the gaming device.

If, in operation 108, the player wishes to transfer funds, then the method can proceed to operation 110, which allows the player to transfer funds. The player can indicate to the slot machine how many credits the player wishes to transfer and in which direction (from the side pot to the main credit meter or from the main credit meter to the side pot). The player can do this using buttons and a standard graphical user interface (GUI) on the gaming device. In one embodiment, the player is free to transfer credits in either direction (from the main credit meter to the side pot and vice versa). In another embodiment, the player is only allowed to transfer credits from the main credit meter to the side pot. In a further embodiment, the player is only allowed to transfer credits from the side pot to the main credit meter.

From operations 108 or 110, the method can proceed to operation 112, which determines whether the player wishes to cash out. If the player does not wish to cash out, then the method can return to operation 102, which allows the player to continue playing the slot game.

If it is determined in operation 112 that the player wishes to cash out, then the method can proceed to operation 114, which cashes out both the main credit meter and the side pot. Both the main credit meter and the side pot will take on a value of 0 and the amounts previously indicated in the main credit meter and the side pot will be disbursed to the player (in the form of cash, coins, electronic payment, cashless ticket, etc.)

FIG. 2 is a drawing illustrating an example of a slot machine with a side pot, according to an embodiment.

A slot machine 200 display shows a first reel 202, a second reel 204, and a third reel 206. The first reel 202, second reel 204, and third reel 206, are used to determine awards for the main credit meter 210. A fourth reel 208 is used to affect the side pot 212. Typically, funds added by the player are added to the main credit meter 210, and when a wager is placed the wager amount is deducted from the main credit meter 210. Typically, the player does not add funds to the side pot (side pot meter), although in an alternative embodiment the player can add funds to the side pot (either directly or by first adding funds to the main credit meter and then transferring such funs to the side pot).

The player can pay to play the main game and the fourth reel and side pot can be resolved automatically without requiring any additional payment from the player. Alternatively, if the player wishes to play the side game (which affects the side pot), the player would be required to place an additional wager (so the side pot can be affected by the spin) along with the main wager (which affects the main credit meter and pays according to a paytable using the resulting symbol combination of the reels). In a further embodiment, the side pot can be deducted (either a fixed amount such as $1 or a percentage of the side pot such as 1%) each time the reels are spun and the side pot can be affected by the reel spin. In this way, the credit meter (main credit meter) is deducted for the main wager which pays an award to the credit meter, while the side pot is also deducted an amount in order for the side pot to be increased or decreased or remain the same in accordance with an outcome of the reels. While the main credit meter will typically not be decreased (but for the original wager amount) when the reels stop spinning, the side pot can be decreased (or increased) based on symbols on the reels.

Described herein, the player is allowed to transfer funds out of the side pot (or cash out) at the player's discretion. In a further embodiment, the player is not allowed to transfer funds out of the side pot into the main credit meter and can only cash out those funds when the player spins the reels and receives a predetermined symbol or combination of symbols on the reel or reels. For example a particular symbol can say “cash out side pot” which would cause the entire contents of the side pot to be transferred to the main credit meter which can be immediately cashed out by the player. This configuration would encourage the player to continue playing as long as funds were in the side pot until the player is able to remove those funds.

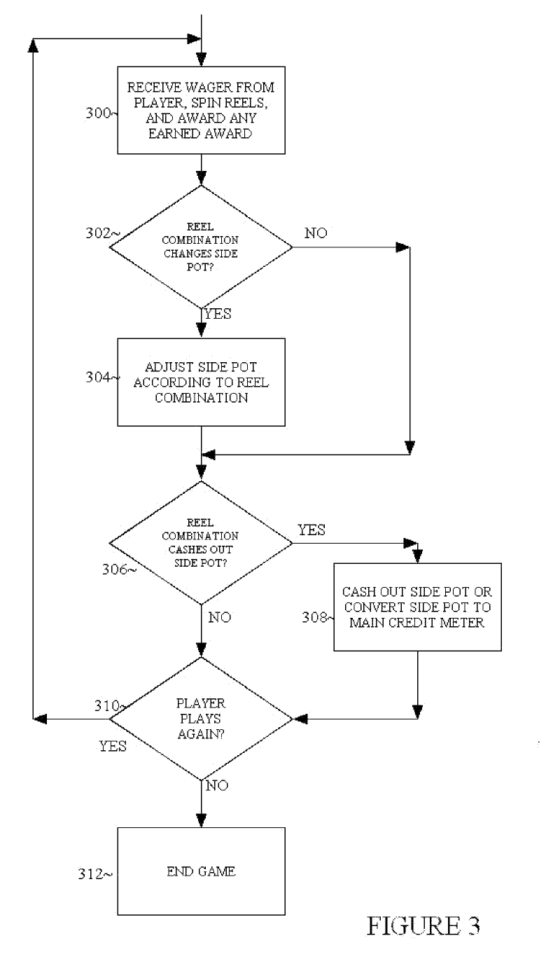

FIG. 3 is a flowchart illustrating an exemplary method of implementing a wagering method with a side pot with automatic cashouts, according to an embodiment.

The method can begin with operation 300 which receives a wager (which is deducted from the main credit meter) from the player, spins the reels to a random resulting combination, and awards any earned award to a main credit meter based on the resulting combination.

The method then proceeds to operation 302, which determines whether the resulting reel combination from operation 300 changes (adds to or subtracts from) the side pot. Different resulting combinations may have different effects on the side pot. Combinations may have different affects on the main credit meter than the side pot. For example, a particular resulting combination may result in a loss on the main credit meter (win of $0) but will result in an increase of $10 on the side pot.

If the determining operation 302 determines that the resulting reel combination changes the side pot, then the method proceeds to operation 304, which adjusts the side pot according to the resulting reel combination (as described herein). For example, the side pot can be multiplied by a constant (e.g., doubled, halved, etc.), increased by a predetermined dollar amount (e.g., the side pot meter increase by $10), decreased by a predetermined number (e.g., decreased by $5), etc.

From either operation 302 or operation 304, the method can proceed to operation 306, which determines whether the resulting reel combination results in a cashing out of the side pot. If the resulting reel combination does not result in a cashing out of the side pot, then the method can proceed to operation 310.

If the determination in operation 306 determines that the resulting reel combination results in a cashing out of the side pot, then the method proceeds to operation 308, which cashes out the side pot or converts the side pot to the main credit meter.

For example, if the side pot is to be cashed out, then the player would instantly receive a predetermined amount of cash (e.g., $10) at his or her machine (either by coin, cashless ticket, electronic debit, etc.)

Alternatively, some or all of the value in the side pot can be converted (transferred) to the main credit meter.

From operations 306 or 308, the method proceeds to operation 310, wherein the player can play again if the player so chooses. If the player wants to play again the method can return to operation 300, otherwise the method can proceed to operation 312 which ends the game.

During operation 310 or 312, the player is free to cash out the entire amount in the main credit meter for cash (e.g., coins at the machine, cashless ticket, electronic debit, etc.) The player is not allowed to cash out any amount in the side pot (instead for the player to redeem any cash amount in the side pot, the player must get particular combinations so that the player/game can reach operation 308 which transfers money from the side pot to the main credit meter).

Table III below illustrates an exemplary paytable which affects both a main credit meter and a side. Of course, the parameters used in Table III are merely exemplary to illustrate the methods described herein.

TABLE II

| Reel combination | main wager | side pot |
|---|---|---|
| 7-7-7 | pays 100:1 | doubles side pot |
| blank-blank-blank | pays 0 | decreases side pot by 10% |
| cherry-any-any | pays 2:1 | transfer 50% of side pot to main credit |
| | | meter |
| bar-bar-bar | pays 5:1 | wipes out side pot |
| bell-bar-bell | pays 0 | increase side pot by $5 |
| 7-wild-7 | pays 0 | transfer all of side pot to main credit |
| | | meter |

Thus, from table II, the player can start by placing a $100 deposit into a slot machine. The side pot is not funded by the player in this embodiment and thus the side pot starts with $0. The player then wagers $1, and receives a 7-7-7, and wins $100 in the main credit meter. Since the side pot is $0, doubling the side pot is still $0. The main credit meter now reads $199 and side pot meter is $0. The player wagers $1 and receives a bell-bar-bell. The main credit meter now reads $198 and the side pot meter is $5. The player is not able to redeem the $5 in the side pot meter at will, but instead the player must hit particular combinations which will transfer the amount in the side pot to the main credit meter. However, the player is always able to redeem (cash out) the full amount in the main credit meter at will. The player then wagers $1 and receives 7-wild-7. The main credit meter now reads $203. The main credit meter dropped from $199 to $198 because of the $1 wager and the 7-wild-7 does not pay anything on the main wager. But the 7-wild-7 combination also transfers all of the side pot to the main credit meter, thus the main credit meter now reads $203 and the side pot meter reads $0. Thus, the player can now cash out all funds in the main credit meter.

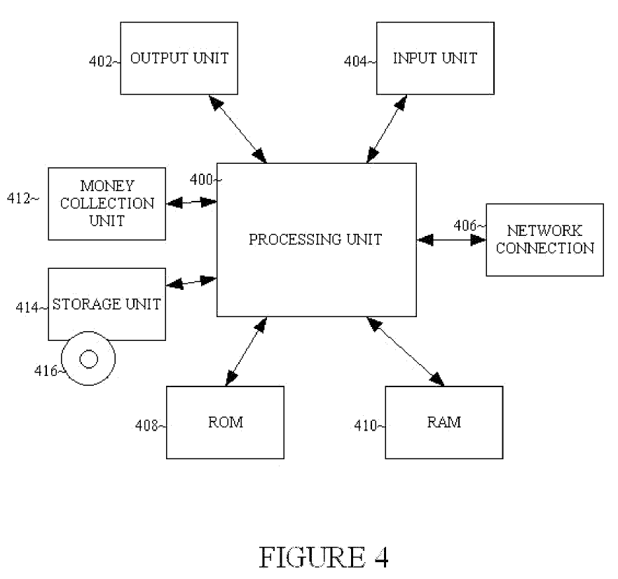

FIG. 4 is a block diagram of one example of hardware that can be used to implement the method, according to an embodiment.

A processing unit 400 (which can comprise a microprocessor and related components) can be connected to an output unit 402 (e.g., LCD or touch screen, etc.), an input unit 404 (e.g. a touch screen, keyboard, buttons, etc.), a network connection 406 (e.g. connection to a casino server or the Internet or other communication network), a ROM 408, a RAM 410, and any other hardware known in the art needed to implemented a digital version of the game (not pictured).

The game can also be served to a remote client playing at an online casino over a computer communications network (such as the Internet). A money collection unit 412 can be used to receive cash (e.g., a bill acceptor), or other payment from such as electronic payment and credit. A storage unit 414 can be a CD-ROM drive, a DVD-ROM drive, or any device that can read a computer readable storage medium. A CD-ROM 416 (or any other type of computer readable storage medium) can be read by the storage unit 414 and can contain data, assets, programs, etc., in order to implement the methods described herein on an electronic gaming machine such as the one illustrated in FIG. 4.

Further, the order of any of the operations described herein can be performed in any order and wagers can be placed/resolved in any order. Any operation described herein can also be optional. Any embodiments herein can also be played in electronic form and programs and/or data for such can be stored on any type of computer readable storage medium (e.g. CD-ROM, DVD, disk, etc.) A mechanical slot machine (using physical reels) can be used to implement the methods described herein, or alternatively a video slot machine can be used, or a combination of the two.

The descriptions provided herein also include any hardware and/or software known in the art and needed to implement the operations described herein. All components illustrated herein may also optionally communicate with any other illustrated or described component.

Further, the methods described herein can be applied to any type of slot machine, whether mechanical (reeled) or video slots, or a combination thereof.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to play a slot machine game, the method comprising:
receiving a monetary deposit to fund a credit meter;
outputting a credit meter indicating funds in the credit meter and outputting a side pot meter indicating funds in the side pot;
receiving a main wager from a player, the main wager being deducted from the credit meter;
spinning slot machines reels to a random resulting combination;
determining an award based on the resulting combination, and awarding any such award to the main credit meter;
determining an effect of the resulting combination on the side pot meter; and
adjusting the side pot amount based on the effect,
wherein the effect on the side pot meter being different than the award to the main credit meter.

2. The method as recited in claim 1, further comprising:
receiving an indication from the player to transfer an amount from the credit meter amount to the side pot amount, and transferring the amount from the credit meter amount to the side pot amount.

3. The method as recited in claim 1, further comprising:
receiving an indication from the player to transfer an amount from the side pot amount to the credit meter amount, and transferring the amount from the side pot amount to the credit meter amount.

4. The method as recited in claim 1, wherein the award is based on N reels, and the effect is based on an outcome of an additional reel not included in the N reels.

5. The method as recited in claim 1, wherein the award and the effect are both based on the resulting combination comprising all reels on the slot machine.

6. The method as recited in claim 1, further comprising determining that the resulting combination comprises a side pot cashout combination, and if so, then automatically transferring the side pot amount to the credit meter amount.

7. The method as recited in claim 1, wherein upon a particular random resulting combination, the player does not receive an award to the main credit meter but receives an increase in credits on the side pot meter.

8. The method as recited in claim 1, wherein upon a particular random resulting combination, the player does receive an award to the main credit meter but does not receive an increase in credits on the side pot meter.

9. The method as recited in claim 1, wherein upon a particular random resulting combination, the player does receive an award to the main credit meter but receives a decrease in credits on the side pot meter.

10. A method to play a slot machine game, the method comprising:
outputting a credit meter amount and a side pot amount;
receiving a main wager from a player, the main wager being deducted from the main credit meter amount;
spinning slot machines reels to a random resulting combination;
determining if a main award is earned based on the resulting combination, and if so, awarding any such award by increasing the main credit meter;
determining if a side pot is affected by the resulting combination, and if so, adjusting the side pot based on the resulting combination; and
determining if an award transfer is earned based on the resulting combination, and if so, transferring a transfer amount of credits from the side pot to the main credit meter,
wherein the player can cash out the credits in the main credit meter but not the side pot.

11. The method as recited in claim 10, wherein the main award is based on N reels, and the effect is based on an outcome of an additional reel not included in the N reels.

12. The method as recited in claim 10, wherein the main award and the side award are both based on the resulting combination comprising all reels on the slot machine.

13. The method as recited in claim 10, wherein a particular resulting combination results in the side pot being given a value of zero.

14. The method as recited in claim 10, wherein a particular resulting combination results in the side pot being multiplied by a constant.

15. A slot machine game apparatus, the apparatus comprising:
an output device outputting a credit meter amount and a side pot amount; and
a processing unit controlling a computer to perform:
receiving a main wager from a player, the main wager being deducted from the credit meter amount;
spinning slot machines reels to a random resulting combination;
determining an award based on the resulting combination, and awarding any such award;
determining an effect of the resulting combination on the side pot amount; and
adjusting the side pot amount based on the effect.

16. The apparatus as recited in claim 15, wherein the processing unit further performs:
receiving an indication from the player to transfer an amount from the credit meter amount to the side pot amount, and transferring the amount from the credit meter amount to the side pot amount.

17. The apparatus as recited in claim 15, wherein the processing unit further performs:
receiving an indication from the player to transfer an amount from the side pot amount to the credit meter amount, and transferring the amount from the side pot amount to the credit meter amount.

18. The apparatus as recited in claim 15, wherein the award is based on N reels, and the effect is based on an outcome of an additional reel not included in the N reels.

19. The apparatus as recited in claim 15, wherein the award and the effect are both based on the resulting combination comprising all reels on the slot machine.

20. The apparatus as recited in claim 15, wherein the processing unit further performs determining that the resulting combination comprises a side pot cashout combination, and if so, then automatically transferring the side pot amount to the credit meter amount.
